(19) United States
(12) Patent Application Publication
(10) Pub. No.: US 2017/0032706 A1
(43) Pub. Date: Feb. 2, 2017

(54) Simulated Organ Device

(71) Applicant: Seiko Epson Corporation, Tokyo (JP)

(72) Inventors: Hirokazu Sekino, Chino-shi (JP); Jiro Ito, Hokuto-shi (JP); Takeshi Seto, Shiojiri-shi (JP)

(21) Appl. No.: 15/217,179

(22) Filed: Jul. 22, 2016

(30) Foreign Application Priority Data
Jul. 31, 2015 (JP) 2015-151704

(51) Int. Cl. G09B 23/30; G09B 23/28

(52) U.S. Cl. CPC G09B 23/303; G09B 23/285

(57) ABSTRACT

A simulated organ device includes a simulated parenchyma that simulates a parenchyma cell, a simulated blood vessel that accommodates a liquid, and that penetrates the simulated parenchyma, and a hydraulic pressure adjustment unit that can adjust pressure of the liquid accommodated in the simulated blood vessel.

### BACKGROUND

1. Technical Field

The present invention relates to a device including a simulated organ.

2. Related Art

According to the related art, as an injection practice device, a structure is known which includes a puncturing unit and a simulated blood vessel (for example, JP-A-2012-203153). The puncturing unit includes a simulated tissue layer corresponding to a simulated parenchyma which simulates a parenchyma of a human body. The simulated blood vessel is arranged so as to penetrate the simulated tissue layer.

In the related art, it is preferable that the simulated parenchyma (simulated tissue layer) and the simulated blood vessel satisfactorily adhere to each other. That is, it is preferable that the simulated blood vessel is stably fixed into the simulated parenchyma. However, as a matter of fact, the related art has not sufficiently studied adjustment for adhesion between the simulated parenchyma and the simulated blood vessel.

### SUMMARY

An advantage of some aspects of the invention is to provide a technique which can adjust adhesion between a simulated parenchyma and a simulated blood vessel.

The invention can be implemented as the following aspects.

(1) An aspect of the invention is directed to a simulated organ device. The simulated organ device includes a simulated parenchyma that simulates a parenchyma cell, a simulated blood vessel that accommodates a liquid, and that penetrates the simulated parenchyma, and a hydraulic pressure adjustment unit that can adjust pressure of the liquid accommodated in the simulated blood vessel. According to the simulated organ device in this aspect, the hydraulic pressure adjustment unit adjusts the pressure of the liquid inside the simulated blood vessel, thereby changing adhesion between the simulated parenchyma and the simulated blood vessel. Therefore, the simulated organ device according to this aspect can adjust the adhesion between the simulated parenchyma and the simulated blood vessel.

(2) In the simulated organ device according to the aspect, the simulated blood vessel may have an intra-parenchyma duct line section included inside the simulated parenchyma, and an extra-parenchyma duct line section drawn outward from the simulated parenchyma. The hydraulic pressure adjustment unit may adjust the pressure of the liquid accommodated in the simulated blood vessel by changing a length of a region for accommodating the liquid, in the extra-parenchyma duct line section. According to this configuration, the length of the region for accommodating the liquid in the extra-parenchyma duct line section is changed by the hydraulic pressure adjustment unit. In this manner, the pressure of the liquid inside the simulated blood vessel is adjusted, and the adhesion between the simulated parenchyma and the simulated blood vessel is changed. Therefore, the simulated organ device according to the aspect with this configuration can easily adjust the adhesion between the simulated parenchyma and the simulated blood vessel.

(3) In the simulated organ device according to the aspect, at least the extra-parenchyma duct line section inside the simulated blood vessel may be configured to be elastically deformable. The hydraulic pressure adjustment unit may include a pair of rollers which can pinch the extra-parenchyma duct line section. A pair of the rollers may be movable to different positions within a range of the extra-parenchyma duct line section. According to the simulated organ device according to the aspect with this configuration, a simple configuration can adjust adhesion between the simulated parenchyma and the simulated blood vessel.

(4) In the simulated organ device according to the aspect, at least the extra-parenchyma duct line section inside the simulated blood vessel may be configured to be elastically deformable. The hydraulic pressure adjustment unit may include a winding roller for winding a side of the extra-parenchyma duct line section which is opposite to the intra-parenchyma duct line section. According to the simulated organ device according to the aspect with this configuration, a simple configuration can adjust adhesion between the simulated parenchyma and each of the intra-parenchyma duct lines.

(5) The simulated organ device according to the aspect may include a plurality of the simulated blood vessels. The hydraulic pressure adjustment units may be respectively disposed corresponding to each of a plurality of the simulated blood vessels. According to the simulated organ device according to the aspect with this configuration, it is possible to individually adjust adhesion between the simulated parenchyma and each of a plurality of the simulated blood vessels.

(6) In the simulated organ device according to the aspect, the simulated blood vessel may have a plurality of the intra-parenchyma duct line sections, and the extra-parenchyma duct line section in which one end side communicates with each of a plurality of the intra-parenchyma duct line sections and the other end side merges into one. The hydraulic pressure adjustment unit may change the length of the region for accommodating the liquid, in the merged portion in the extra-parenchyma duct line section. According to this configuration, the length of the region for accommodating the liquid in the extra-parenchyma duct line section is changed by the hydraulic pressure adjustment unit. In this manner, adhesion between the simulated parenchyma and each intra-parenchyma duct line section is changed at a time. Therefore, the simulated organ device according to the aspect with this configuration can adjust the adhesion of each simulated blood vessel adhering to the simulated parenchyma at a time.

(7) In the simulated organ device according to the aspect, the hydraulic pressure adjustment unit may include a liquid storage unit which is connected to the simulated blood vessel and which stores the liquid, and a liquid storage unit support unit which has a configuration capable of changing a supporting position for the liquid storage unit into a vertically different position and which adjusts the pressure of the liquid accommodated in the simulated blood vessel, depending on the supporting position. According to the simulated organ device according to the aspect with this configuration, a simple configuration can adjust adhesion between the simulated parenchyma and the simulated blood vessel.

(8) In the simulated organ device according to the aspect, a configuration may be adopted in which the simulated parenchyma can be excised by a liquid ejected from a liquid ejecting apparatus. According to the simulated organ device according to the aspect with this configuration, the simulated organ device can be used for the liquid ejecting apparatus.

The invention can be implemented in various forms in addition to the above-described configurations. For example, the invention can be implemented as a control device of the stimulated organ.

### BRIEF DESCRIPTION OF THE DRAWINGS

The invention will be described with reference to the accompanying drawings, wherein like numbers reference like elements.

FIG. 1 schematically illustrates a configuration of a liquid ejecting apparatus.

FIG. 2 is a view for describing a simulated organ device according to a first embodiment.

FIG. 3 is a plan view illustrating a simulated organ.

FIG. 4 is a sectional view taken along line A-A in FIG. 3.

FIG. 5 is a view for describing the simulated organ device when a hydraulic pressure adjustment mechanism is moved.

FIG. 6 is a graph illustrating a correlation between a length of a region A3 and pressure of sealed liquid.

FIG. 7 is a view for describing a simulated organ device according to a second embodiment.

FIG. 8 is a view for describing a simulated organ device according to a third embodiment.

FIG. 9 is a view for describing a simulated organ device according to a fourth embodiment.

FIG. 10 is a view for describing a simulated organ device according to a fifth embodiment.

### DESCRIPTION OF EXEMPLARY EMBODIMENTS

Next, embodiments according to the invention will be described. A liquid ejecting apparatus will be first described which is used in order to excise a simulated organ included in a simulated organ device according to the embodiments.

### A. First Embodiment

### A-1. Configuration of Liquid Ejecting Apparatus

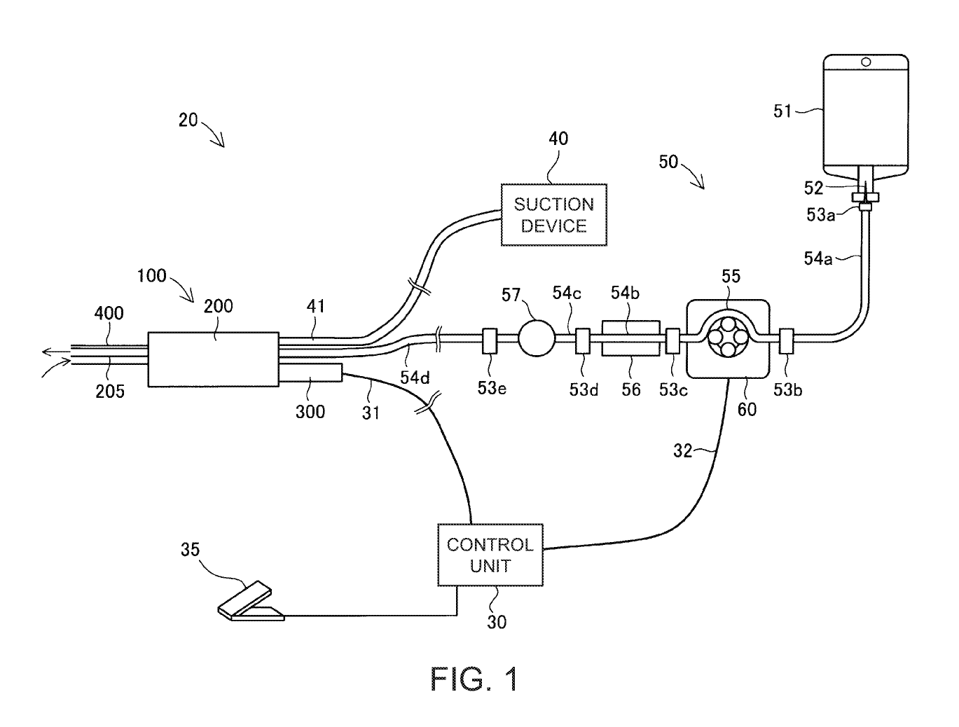

FIG. 1 schematically illustrates a configuration of a liquid ejecting apparatus 20. The liquid ejecting apparatus 20 is a medical device used in medical institutions, and has a function to excise a lesion by ejecting a liquid to the lesion.

The liquid ejecting apparatus 20 includes a control unit 30, an actuator cable 31, a pump cable 32, a foot switch 35, a suction device 40, a suction tube 41, a liquid supply device 50, and a handpiece 100.

The liquid supply device 50 includes a water supply bag 51, a spike needle 52, first to fifth connectors 53a to 53e, first to fourth water supply tubes 54a to 54d, a pump tube 55, a clogging detection mechanism 56, and a filter 57. The handpiece 100 includes a nozzle unit 200 and an actuator unit 300. The nozzle unit 200 includes an ejecting tube 205 and a suction pipe 400.

The water supply bag 51 is made of a transparent synthetic resin, and the inside thereof is filled with a liquid (specifically, a physiological saline solution). In the present application, even if a bag is filled with liquids other than the water, the bag is called the water supply bag 51. The spike needle 52 is connected to the first water supply tube 54a via the first connector 53a. If the spike needle 52 is stuck into the water supply bag 51, the liquid filling the water supply bag 51 is in a state where the liquid can be supplied to the first water supply tube 54a.

The first water supply tube 54a is connected to the pump tube 55 via the second connector 53b. The pump tube 55 is connected to the second water supply tube 54b via the third connector 53c. The tube pump 60 pinches the pump tube 55. The tube pump 60 feeds the liquid inside the pump tube 55 to the second water supply tube 54b side from the first water supply tube 54a side.

The clogging detection mechanism 56 detects clogging inside the first to fourth water supply tubes 54a to 54d by measuring pressure inside the second water supply tube 54b.

The second water supply tube 54b is connected to the third water supply tube 54c via the fourth connector 53d. The filter 57 is connected to the third water supply tube 54c. The filter 57 collects foreign substances contained in the liquid.

The third water supply tube 54c is connected to the fourth water supply tube 54d via the fifth connector 53e. The fourth water supply tube 54d is connected to the nozzle unit 200. The liquid supplied through the fourth water supply tube 54d is intermittently ejected from a distal end of the ejecting tube 205 by driving the actuator unit 300. The liquid is intermittently ejected in this way. Accordingly, it is possible to ensure excision capability using a small flow rate.

The ejecting tube 205 and the suction pipe 400 configure a double tube in which the ejecting tube 205 serves as an inner tube and the suction pipe 400 serves as an outer tube. The suction tube 41 is connected to the nozzle unit 200. The suction device 40 performs suction on the inside of the suction pipe 400 through the suction tube 41. The suction is performed on the liquid or excised fragments in the vicinity of the distal end of the suction pipe 400.

The control unit 30 controls the tube pump 60 and the actuator unit 300. Specifically, while the foot switch 35 is stepped on, the control unit 30 transmits a drive signal via the actuator cable 31 and the pump cable 32. The drive signal transmitted via the actuator cable 31 drives a piezoelectric element (not illustrated) included in the actuator unit 300. The drive signal transmitted via the pump cable 32 drives the tube pump 60. Accordingly, while a user steps on the foot switch 35, the liquid is intermittently ejected. While the user does not step on the foot switch 35, the liquid ejection is stopped.

### A-2. Configuration of Simulated Organ Device

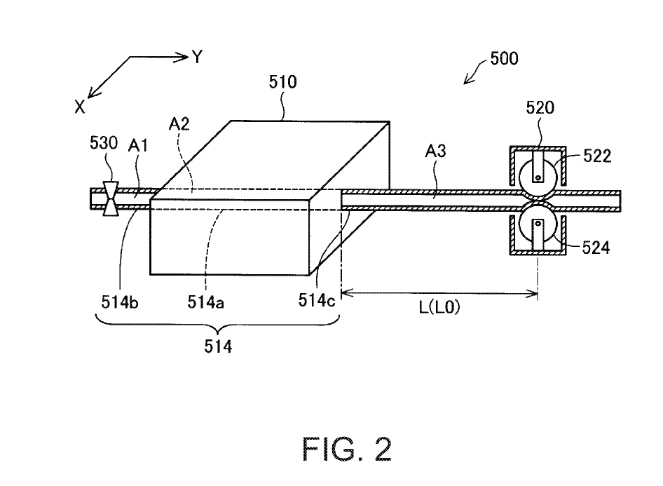

FIG. 2 is a view for describing a simulated organ device 500 according to the first embodiment. As illustrated in the drawing, the simulated organ device 500 includes a simulated organ 510 and a hydraulic pressure adjustment mechanism 520. The simulated organ 510 is also called a phantom, and is an artificial product whose portion is excised by the liquid ejecting apparatus 20 in the present embodiment. The simulated organ device 500 according to the embodiment is used in performing a simulated operation for the purpose of a performance evaluation of the liquid ejecting apparatus 20, a manipulation practice of the liquid ejecting apparatus 20, and the like.

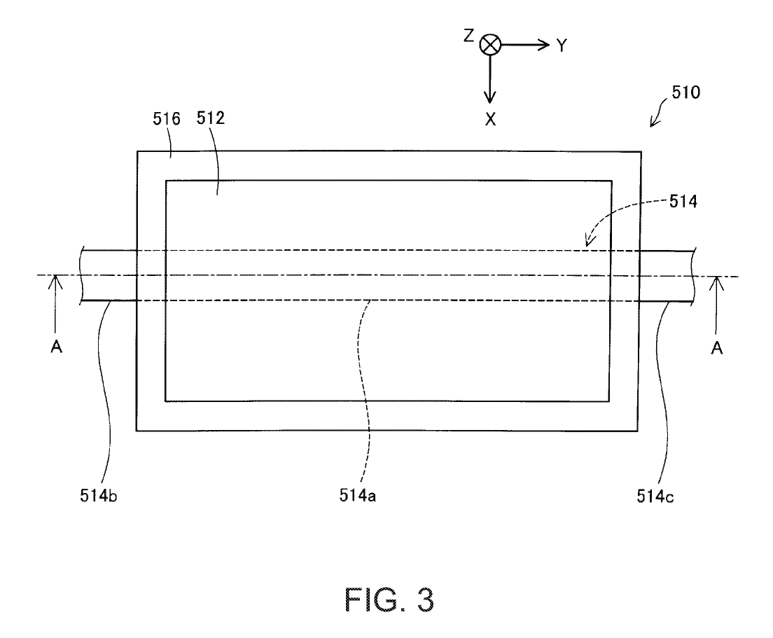

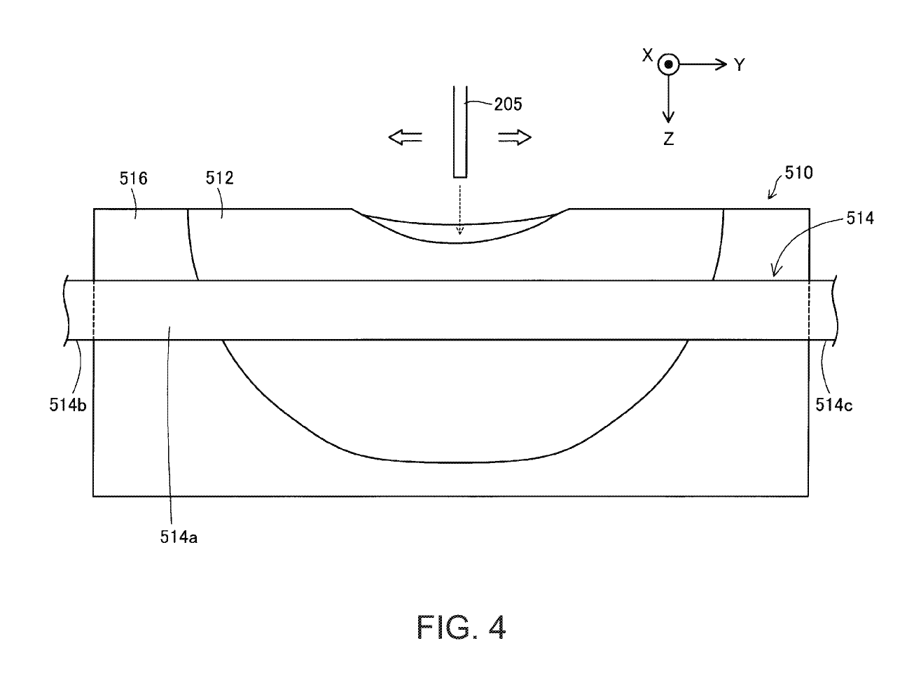

FIGS. 3 and 4 illustrate the simulated organ 510. FIG. 3 illustrates a plan view, and FIG. 4 illustrates a sectional view taken along line A-A in FIG. 3. In the embodiment, a horizontal plane is referred to as a plane X-Y, and a vertical direction (depth direction) is referred to as a direction Z.

The simulated organ 510 includes a simulated parenchyma 512, a simulated blood vessel 514, and a support member 516.

The simulated parenchyma 512 is an artificial product which simulates a parenchyma (parenchyma cell) of a human body organ (for example, a human brain, liver, or the like). The parenchyma is a cell which directly relates to a characteristic function of the organ. As a material of the simulated parenchyma 512, polyvinyl alcohol (PVA) is employed. Instead of the PVA, a rubber-based material other than the PVA or urethane can be employed.

The simulated blood vessel 514 is an artificial product which simulates a blood vessel of a living body (for example, a human cerebral blood vessel), and has a hollow shape. As a material of the simulated blood vessel 514, the PVA is employed. The simulated blood vessel 514 is embedded inside the simulated parenchyma 512, and penetrates the simulated parenchyma 512. The simulated blood vessel 514 is a member which has to avoid damage in a simulated operation. A predetermined liquid serving as a simulated blood is accommodated inside the simulated blood vessel 514. For example, the predetermined liquid is water colored in red, blue, or the like.

The simulated parenchyma 512 and the simulated blood vessel 514 are supported by the support member 516. For example, the support member 516 is a metal-made container which supports the simulated parenchyma 512 by accommodating the simulated parenchyma 512, and which supports the simulated blood vessel 514 in a state where the simulated blood vessel 514 is inserted and fitted into the support member 516. That is, the simulated blood vessel 514 is arranged in a direction Y in the drawing, and penetrates the simulated parenchyma 512 and a portion of the support member 516. Both ends of the simulated blood vessel 514 extend to the outside of the support member 516. That is, the simulated blood vessel 514 has an intra-parenchyma duct line section 514a which is included inside the support member 516 for accommodating the simulated parenchyma 512, a first extra-parenchyma duct line section 514b which is drawn outward from one end portion of the support member 516 for accommodating the simulated parenchyma 512, and a second extra-parenchyma duct line section 514c which is drawn outward from the other end portion of the support member 516 for accommodating the simulated parenchyma 512.

As illustrated in FIG. 2, an end portion of the first extra-parenchyma duct line section 514b which is opposite to the intra-parenchyma duct line section 514a is sealed with a sealing material 530. The hydraulic pressure adjustment mechanism 520 is provided in an intermediate portion of the second extra-parenchyma duct line section 514c.

The hydraulic pressure adjustment mechanism 520 includes a pair of rollers 522 and 524, and causes a pair of the rollers 522 and 524 to crush (pinch) a portion of the second extra-parenchyma duct line section 514c, thereby sealing the second extra-parenchyma duct line section 514c. As a result, a region A1 from one end on the intra-parenchyma duct line section 514a side in the first extra-parenchyma duct line section 514b to the sealing material 530, a region A2 of the intra-parenchyma duct line section 514a, and a region A3 from one end on the intra-parenchyma duct line section 514a side in the second extra-parenchyma duct line section 514c to a position sealed with the hydraulic pressure adjustment mechanism 520 are caused to have a simulated blood sealed therein.

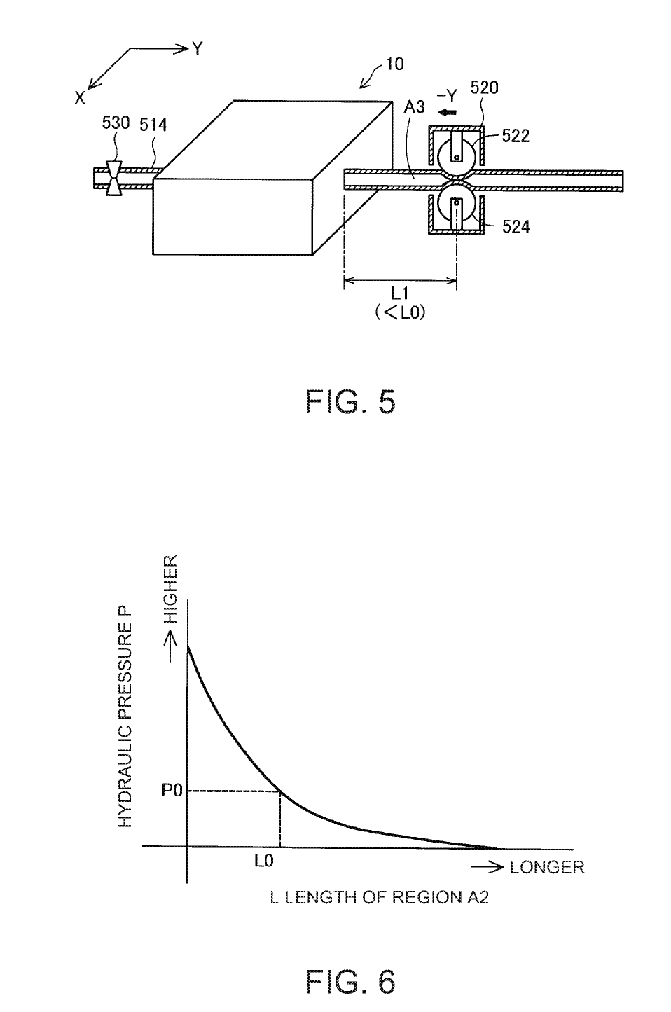

The hydraulic pressure adjustment mechanism 520 is configured to be movable along the direction Y (both positive and negative directions) in the drawing. The movement is manually performed by a user. The movement changes a length L of the above-described region A3. A position of the hydraulic pressure adjustment mechanism 520 illustrated in FIG. 2 is an initial position. The length L at the initial position is set to as L0. For example, in a case where the hydraulic pressure adjustment mechanism 520 moves from the initial position in a direction −Y as illustrated in FIG. 5, the length L of the above-described region A3 is set to L1 which is shorter than the length L0 of the initial position. If the length L of the region A3 is shortened, pressure of the liquid sealed in a range of the region A1, the region A2, and the region A3 increases corresponding to a decreased volume, compared to a case of the initial position. When the hydraulic pressure adjustment mechanism 520 moves, the liquid does not flow outward from a side opposite to the intra-parenchyma duct line section 514a in the second extra-parenchyma duct line section 514c. Alternatively, even if the liquid flows outward, the amount of the liquid is so insignificant as not to influence an increase in the pressure. Accordingly, it is possible to reliably adjust the pressure of the sealed liquid inside the range of the region A1, the region A2, and the region A3.

FIG. 6 is a graph illustrating a correlation between the length L of the region A3 and pressure (hydraulic pressure) P of the liquid sealed in the range of the region A1, the region A2, and the region A3. As described above, a volume of the sealed liquid inside the range of the region A1, the region A2, and the region A3 does not vary even if the position of the hydraulic pressure adjustment mechanism 520 is changed. Therefore, as illustrated in the graph, in response to the shortened length L of the region A3, the hydraulic pressure P increases. That is, if the length L of the region A3 is gradually shortened compared to the length L0 at the initial position, the volume for accommodating the liquid decreases. In contrast, since the volume of the liquid does not vary, the hydraulic pressure P gradually increases compared to hydraulic pressure P0 at the initial position. Similarly, if the length L of the region A3 is gradually lengthened compared to the length L0, the hydraulic pressure P gradually decreases compared to the hydraulic pressure P0.

### A-3. Advantageous Effect of Embodiment

According to the simulated organ device 500 configured as described above, the hydraulic pressure adjustment mechanism 520 adjusts the pressure of the liquid inside the simulated blood vessel 514. Accordingly, adhesion between the simulated parenchyma 512 and the simulated blood vessel 514 varies. Therefore, the simulated organ device according to the embodiment can adjust the adhesion between the simulated parenchyma 512 and the simulated blood vessel 514. As a result, the simulated blood vessel 514 can be stably held inside the simulated parenchyma 512. In particular, in the simulated organ device 500 according to the embodiment, the length of the region A3 having the sealed liquid in the second extra-parenchyma duct line section 514c is changed by the hydraulic pressure adjustment mechanism 520. In this manner, the pressure of the liquid inside the simulated blood vessel 514 is adjusted, and the adhesion between the simulated parenchyma 512 and the simulated blood vessel 514 is changed. Therefore, the simulated organ device 500 according to the embodiment can easily adjust the adhesion between the simulated parenchyma 512 and the simulated blood vessel 514.

In addition, according to the simulated organ device 500, since the pressure of the liquid inside the simulated blood vessel 514 is adjusted, it is possible to easily test the influence such as blood vessel damage caused by an internal pressure difference.

### B. Second Embodiment

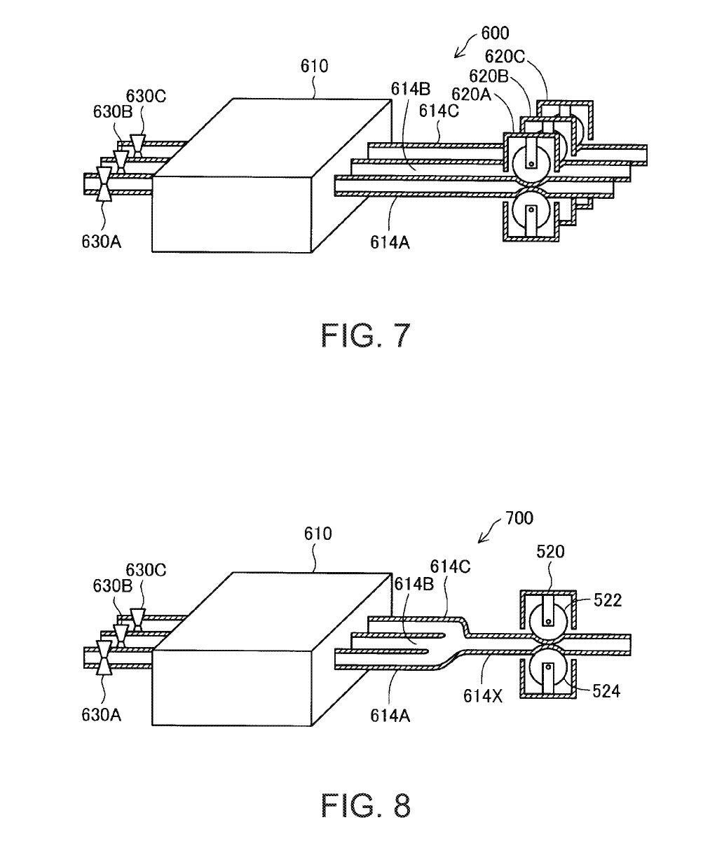

FIG. 7 is a view for describing a simulated organ device 600 according to a second embodiment. Compared to the simulated organ device 500 according to the first embodiment, the simulated organ device 600 according to the second embodiment adopts a different configuration which includes a plurality of simulated blood vessels 614A, 614B, and 614C, and a plurality of hydraulic pressure adjustment mechanisms 620A, 620B, and 620C.

The respective simulated blood vessels 614A, 614B, and 614C are the same as the simulated blood vessel 514 according to the first embodiment, and the respective hydraulic pressure adjustment mechanisms 620A, 620B, and 620C are the same as the hydraulic pressure adjustment mechanism 520 according to the first embodiment. Similarly to the first embodiment, one end side of the respective simulated blood vessels 614A, 614B, and 614C are sealed with respective sealing materials 630A, 630B, and 630C. Similarly to the first embodiment, the other end side of the respective simulated blood vessels 614A, 614B, and 614C are provided with the respective hydraulic pressure adjustment mechanisms 620A, 620B, and 620C. The remaining configurations in the simulated organ device 600 are the same as those according to the first embodiment.

Similarly to the first embodiment, the simulated organ device 600 configured as described above can adjust the adhesion between the simulated parenchyma and the simulated blood vessels 614A, 614B, and 614C. In particular, the simulated organ device 600 according to the embodiment can individually adjust the adhesion between each of a plurality of the simulated blood vessels 614A, 614B, and 614C and the simulated parenchyma. In addition, the simulated organ device 600 can align the internal pressure of the simulated blood vessels 614A, 614B, and 614C with each other. Therefore, it is possible to easily test the simulated blood vessels having the same property.

### C. Third Embodiment

FIG. 8 is a view for describing a simulated organ device 700 according to a third embodiment. Compared to the simulated organ device 600 according to the second embodiment, the simulated organ device 700 according to the third embodiment has a different configuration in which a plurality of the simulated blood vessels 614A, 614B, and 614C merge into one on the other end side, and in which one hydraulic pressure adjustment mechanism 520 is disposed in the merged portion. The remaining configurations are the same as those according to the second embodiment. The hydraulic pressure adjustment mechanism. 520 is the same as the hydraulic pressure adjustment mechanism 520 according to the first embodiment.

Similarly to the second embodiment, the simulated organ device 700 configured as described above can adjust the adhesion between the simulated parenchyma and the simulated blood vessels 614A, 614B, and 614C. In particular, in the simulated organ device 700 according to the embodiment, the adhesion between each of a plurality of the simulated blood vessels 614A, 614B, and 614C and the simulated parenchyma is changed at a time. Therefore, the simulated organ device 700 according to the embodiment can adjust the adhesion of the respective simulated blood vessels 614A, 614B, and 614C adhering to the simulated parenchyma at a time. In addition, the simulated organ device 700 can individually adjust the pressure of the liquid in the simulated blood vessels 614A, 614B, and 614C. Therefore, it is possible to easily test the influence such as blood vessel damage caused by an internal pressure difference.

### D. Fourth Embodiment

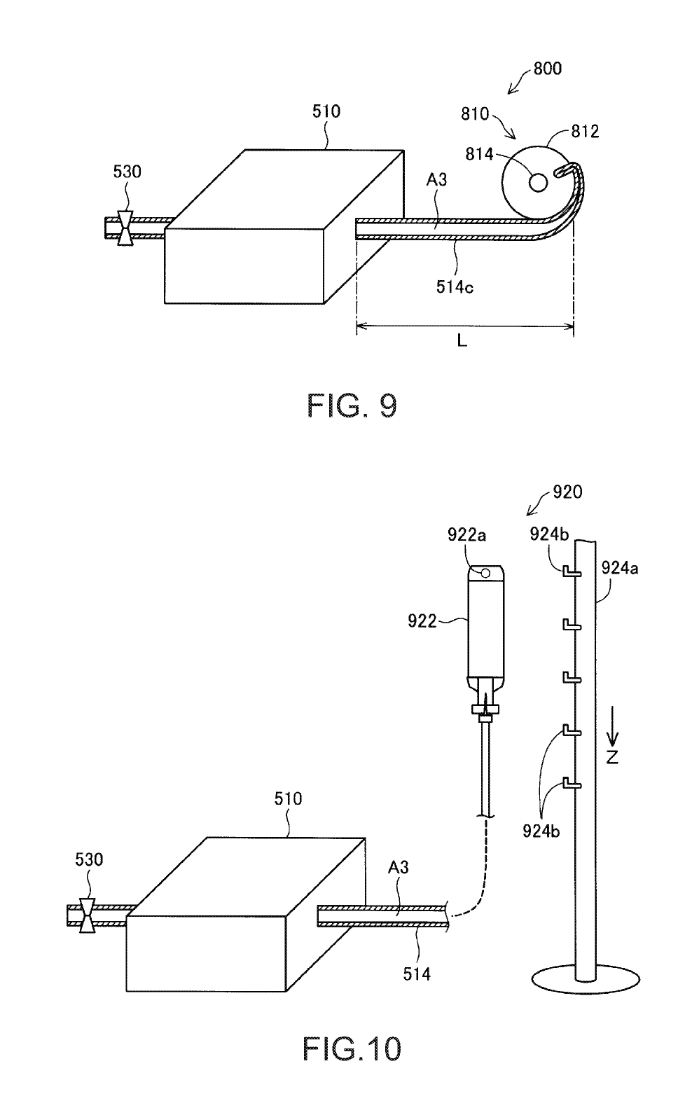

FIG. 9 is a view for describing a simulated organ device 800 according to a fourth embodiment. The simulated organ device 500 according to the first embodiment adopts a configuration in which the length of the region A3 having the sealed liquid in the second extra-parenchyma duct line section 514c is changed by a pair of the rollers 522 and 524. In contrast, in the simulated organ device 800 according to the fourth embodiment, a side of the second extra-parenchyma duct line section 514c, which is opposite to the intra-parenchyma duct line section, is wound by a winding roller 810. The opposite side is crushed, thereby changing the length L of the region A3 having the sealed liquid in the second extra-parenchyma duct line section 514c.

Similarly to the first embodiment, according to the simulated organ device 800 configured as described above, an easy configuration can adjust the adhesion between the simulated parenchyma and the simulated blood vessel.

The simulated organ device 800 according to the fourth embodiment adopts a configuration in which the hydraulic pressure adjustment mechanism in the simulated organ device 500 according to the first embodiment is replaced with the winding roller. Instead of this configuration, a configuration may be adopted in which the hydraulic pressure adjustment mechanism in the simulated organ device 500 according to the second embodiment or the simulated organ device 600 according to the third embodiment is replaced with the winding roller.

### E. Fifth Embodiment

FIG. 10 is a view for describing a simulated organ device 900 according to a fifth embodiment. Compared to the simulated organ device 500 according to the first embodiment, the simulated organ device 900 according to the fifth embodiment has a different configuration of a hydraulic pressure adjustment mechanism 920. The simulated organ 510 in the remaining configurations is the same as that according to the first embodiment.

The hydraulic pressure adjustment mechanism 920 includes a liquid bag 922 and a liquid bag support unit 924. The liquid bag 922 is connected to the simulated blood vessel 514 of the simulated organ 510, and stores the liquid serving as the simulated blood.

The liquid bag support unit 924 includes a pole 924a erected in the vertical direction (that is, upward and downward direction) Z. A plurality of hooks 924b having a key shape are arranged in the pole 924a. A plurality of the hooks 924b are arranged at different positions in the height direction. A supporting hole 922a is disposed in the liquid bag 922. The hook 924b is inserted into the hole 922a, thereby attaching the liquid bag 922 to the pole 924a. A user can change the attachment position of the liquid bag 922 to the vertically different positions by changing the inserting-target hook 924b.

If the attachment position of the liquid bag 922 is changed in the vertical direction Z, the weight of the liquid changes the pressure of the liquid inside the simulated blood vessel 514. That is, if the attachment position of the liquid bag 922 is raised, the pressure of the liquid accommodated inside the simulated blood vessel 514 can be increased. On the other hand, if the attachment position of the liquid bag 922 is lowered, the pressure of the liquid accommodated inside the simulated blood vessel 514 can be decreased.

Similarly to the first embodiment, according to the simulated organ device 800 configured as described above, an easy configuration can adjust the adhesion between the simulated parenchyma and the simulated blood vessel. In particular, according to the embodiment, it is possible to easily adjust the pressure of the liquid accommodated in the simulated blood vessel 514 by changing the attachment position of the liquid bag 922 vertically.

### F. Modification Example

Without being limited to the respective embodiments, and modification examples thereof, the invention can be implemented according to various configurations within the scope not departing from the gist of the invention. For example, the following modification examples can be adopted.

### Modification Example 1

The respective embodiments and the modification examples adopt a configuration in which both ends of the simulated blood vessel extend to the outside of the support member. In contrast, as a modification example, a configuration may also be adopted in which one end of the simulated blood vessel is installed inside the support member. An end portion on the installed side of the simulated blood vessel is sealed, and the hydraulic pressure adjustment mechanism is disposed on the side extending to the outside. The configuration according to this modification example can also provide an advantageous effect which is the same as that according to the respective embodiments.

### Modification Example 2

The first to third embodiments adopt a configuration in which the length of the region A3 having the sealed liquid in the second extra-parenchyma duct line section is changed by a pair of the rollers. However, instead of this configuration, a configuration may also be adopted in which the length is changed by shifting a member having other shapes such as a plate shape and the like. That is, as long as the shape of the simulated blood vessel can be changed, any configuration may be adopted. The configuration according to this modification example can also provide an advantageous effect which is the same as that according to the respective embodiments.

### Modification Example 3

The respective embodiments and the modification examples may adopt a configuration in which a gauge is attached to an outer surface of the second extra-parenchyma duct line section 514c of the simulated blood vessel 514. The gauge is disposed along the longitudinal direction of the simulated blood vessel 514. A scale of the gauge varies in the longitudinal direction of the simulated blood vessel 514. According to the configuration in this modification example, the length of the region A3 having the sealed liquid can be accurately determined by a user in a visible manner. Furthermore, a pressure sensor may be disposed in order to measure the pressure inside the simulated blood vessel 514. According to this configuration, it is possible to more accurately adjust the hydraulic pressure.

### Modification Example 4

The respective embodiments and the modification examples employ the PVA as a material of the simulated blood vessel, but a configuration is not limited thereto. For example, a synthetic resin other than the PVA (for example, urethane) may be employed, or a natural resin may be employed. In addition, according to the respective embodiments and the modification examples, the intra-parenchyma duct line section and the extra-parenchyma duct line section in the simulated blood vessel are formed of the same material. However, instead of this configuration, different materials may be used. In a case of the different materials, it is preferable to adopt a configuration in which the extra-parenchyma duct line section located within the movement range of the hydraulic pressure adjustment unit is at least elastically deformable in a case where the hydraulic pressure adjustment unit performs a crushing operation.

### Modification Example 5

The simulated organ may be excised by means other than the liquid ejected from the liquid ejecting apparatus. For example, the simulation organ may be excised by using a continuously ejected liquid, or may be excised by a liquid provided with excision capability using an ultrasound or an optical maser. Alternatively, the simulation organ may be excised by using a metal scalpel.

### Modification Example 6

The embodiments adopt a configuration in which the piezoelectric element is used as the actuator. However, the embodiments may adopt a configuration in which the liquid is ejected by using the optical maser, or a configuration in which the liquid is ejected by a pump pressurizing the liquid. According to the configuration in which the liquid is ejected by using the optical maser, the optical maser emits radiation to the liquid so as to generate the air bubbles in the liquid, and increased pressure of the liquid which is caused by generating the air bubbles is utilized.

### Modification Example 7

In the first to third embodiments, the pressure of the liquid inside the simulated blood vessel 514 is adjusted by changing the position of the hydraulic pressure adjustment mechanism 520, but a configuration is not limited thereto. The other end of the simulated blood vessel 514 may be sealed with a sealing material different from the hydraulic pressure adjustment mechanism 520. In this manner, a configuration may be adopted which adjusts whether or not the rollers 522 and 524 (contact portions) of the hydraulic pressure adjustment mechanism 520 are brought into contact with the simulated blood vessel 514, or which adjusts how much the simulated blood vessel has to be deformed by the rollers.

### Modification Example 8

In the embodiments, the liquid is accommodated in the simulated blood vessel. However, a configuration may be adopted in which a fluid other than the liquid, such as gas, powder, and the like, is accommodated therein instead of the liquid. In addition, for example, as the predetermined liquid, water colored in red, blue, or the like is employed. However, as long as an operator can recognize damage to the simulated blood vessel, any means may be employed. Accordingly, in addition to the coloring, a configuration may be adopted in which light is emitted when the fluid leaks outward from the simulated blood vessel, or in which the color of the fluid is changed by reacting with the simulated parenchyma when leaking. In addition, the coloring may not be performed.

### Modification Example 9

The embodiments adopt a configuration in which the liquid is not supplied from a liquid tank or the like disposed outside the simulated organ when the hydraulic pressure adjustment mechanism adjusts the hydraulic pressure, but a configuration is not limited thereto. A configuration may be adopted which adjusts the pressure by disposing a supply tank or a liquid discharge tank outside the simulated organ, and by adjusting the amount of the liquid supplied to the simulated blood vessel from the supply tank or the amount of the liquid to be discharged to the liquid discharge tank from the simulated blood vessel. A configuration may also be adopted in which the liquid is caused to return to the supply tank without disposing the liquid discharge tank. A configuration may be adopted in which driving a supply pump is controlled so as to adjust the amount of the liquid. In this way, a configuration may be adopted which adjusts the amount of the liquid accommodated in the simulated blood vessel.

Without being limited to the embodiment, the example, and the modification example which are described herein, the invention can be implemented according to various configurations within the scope not departing from the gist of the invention. For example, technical features in the embodiment, the example, and the modification example which correspond to technical features according to each aspect described in the summary of the invention can be appropriately replaced or combined with each other in order to partially or entirely solve the previously described problem or in order to partially or entirely achieve the previously described advantageous effects. If any one of the technical features is not described herein as essential, the technical feature can be appropriately omitted.

The entire disclosure of Japanese Patent Application No. 2015-151704 filed Jul. 31, 2015 is expressly incorporated by reference herein.

What is claimed is:

1. A simulated organ device comprising:
a simulated parenchyma that simulates a parenchyma cell;
a simulated blood vessel that accommodates a liquid, and that penetrates the simulated parenchyma; and
a hydraulic pressure adjustment unit that can adjust pressure of the liquid accommodated in the simulated blood vessel.

2. The simulated organ device according to claim 1,
wherein the simulated blood vessel has an intra-parenchyma duct line section included inside the simulated parenchyma, and an extra-parenchyma duct line section drawn outward from the simulated parenchyma, and
wherein the hydraulic pressure adjustment unit adjusts the pressure of the liquid accommodated in the simulated blood vessel by changing a length of a region for accommodating the liquid, in the extra-parenchyma duct line section.

3. The simulated organ device according to claim 2,
wherein at least the extra-parenchyma duct line section inside the simulated blood vessel is configured to be elastically deformable,
wherein the hydraulic pressure adjustment unit includes a pair of rollers which can pinch the extra-parenchyma duct line section, and
wherein a pair of the rollers are movable to different positions within a range of the extra-parenchyma duct line section.

4. The simulated organ device according to claim 2,
wherein at least the extra-parenchyma duct line section inside the simulated blood vessel is configured to be elastically deformable, and
wherein the hydraulic pressure adjustment unit includes a winding roller for winding aside of the extra-parenchyma duct line section which is opposite to the intra-parenchyma duct line section.

5. The simulated organ device according to claim 1, comprising:
a plurality of the simulated blood vessels,
wherein the hydraulic pressure adjustment units are respectively disposed corresponding to each of a plurality of the simulated blood vessels.

6. The simulated organ device according to claim 2,
wherein the simulated blood vessel has a plurality of the intra-parenchyma duct line sections, and the extra-parenchyma duct line section in which one end side communicates with each of a plurality of the intra-parenchyma duct line sections and the other end side merges into one, and
wherein the hydraulic pressure adjustment unit changes the length of the region for accommodating the liquid, in the merged portion in the extra-parenchyma duct line section.

7. The simulated organ device according to claim 1,
wherein the hydraulic pressure adjustment unit includes a liquid storage unit which is connected to the simulated blood vessel and which stores the liquid, and a liquid storage unit support unit which has a configuration capable of changing a supporting position for the liquid storage unit into a vertically different position and which adjusts the pressure of the liquid accommodated in the simulated blood vessel, depending on the supporting position.

8. The simulated organ device according to claim 1,
wherein the simulated parenchyma can be excised by a liquid ejected from a liquid ejecting apparatus.
